(19) United States
(12) Patent Application Publication
(10) Pub. No.: US 2025/0041782 A1
(43) Pub. Date: Feb. 6, 2025

(54) AIR-PARTICLE SEPARATION SYSTEM

(71) Applicant: JOHN BRADFORD DAVIDSON, Vicksburg, MS (US)

(72) Inventor: JOHN BRADFORD DAVIDSON, Vicksburg, MS (US)

(21) Appl. No.: 18/228,600

(22) Filed: Jul. 31, 2023

(51) Int. Cl. B01D 47/06; B01D 46/00; B01D 46/42; B01D 46/682; B01D 46/79; B01D 50/60

(52) U.S. Cl. CPC B01D 47/06; B01D 46/0049; B01D 46/0084; B01D 46/4245; B01D 46/682; B01D 46/79; B01D 50/60

(57) ABSTRACT

The air-particle separation system is a dust handler that includes a main body with a misting module mounted thereon. The misting module includes air input pipes for receiving air with particles and a misting nozzle for soaking the particles within the air stream. The water particles and air are directed downwardly into a screen basket that is supported in a first chamber. A screen purging nozzle removes any particles stuck to the screen. Air is pulled through the system by a suction fan. An optional high-pressure fan may also be provided. The water, the water-soaked particles, and the air exit the screen basket and enter the first chamber and a second chamber. Air is removed from the chambers through the fan(s), while a drain in the bottom of the chambers drains the water and particles.

### BACKGROUND

### 1. Field

The disclosure of the present patent application relates to dust separation systems for air streams, and particularly to an air-particle separation system.

### 2. Description of the Related Art

In general, dust and particulate separation systems for air streams are used in the food industry as well other industries. In the food industry, an air knife is typically used to blow away excess dust particles from the product being produced, such as chicken tenders, steak fingers, powdered donuts, and other powdered products. The air knife can be used on any breading or dust coating system in the food industry. The particles in the air from these processes must be removed, prior to releasing the air into the atmosphere or returning the air to the processes. The conventional dust and particulate separation systems typically use components such as bag houses, cyclones, large blowers, sock filters, air cannons, ducting, blowout panels (required for the possibility of a dust explosion) for this purpose. These systems typically include a sprinkler or fire system and are usually placed outside to avoid explosion hazards. This requires extensive ductwork and a pressure drop due to the distance between the dust and particulate separation system and the dust producing equipment.

Thus, an air-particle separation system solving the afore-mentioned problems is desired.

### SUMMARY

An air-particle separation system is a dust handler that operates as a “wet system” and can be built in various sizes to fit particular dust handling requirements. The system does not require the maintenance of intensive and dangerous components of a conventional dust handler and, thereby, minimizes explosion hazards. As such, the system can be located next to equipment producing dust-laden air.

The system includes a includes a main body with a misting module mounted thereon. The misting module includes air input pipes for receiving air with particles and a misting nozzle for soaking the particles within the air stream. The water particles and air are directed downwardly into a screen basket that is supported in a first chamber. A screen purging nozzle removes any particles stuck to the screen. Air is pulled through the system by a suction fan. An optional high-pressure fan may also be provided. The water, the water-soaked particles, and the air exit the screen basket and enter the first chamber and a second chamber. Air is removed from the chambers through the fan(s), while a drain in the bottom of the chambers drains the water and particles.

These and other features of the present subject matter will become readily apparent upon further review of the following specification.

### BRIEF DESCRIPTION OF THE DRAWINGS

FIG. 1 is an environmental front view of an air-particle separation system.

FIG. 2 is an environmental rear view of the air-particle separation system of FIG. 1.

FIG. 3 is a rear view of the air-particle separation system of FIG. 1, with its rear access panel open.

FIG. 4 is an enlarged isometric view of a fan motor and other components of the air-particle separation system of FIG. 1.

FIG. 5 is an environmental, isometric right-side view of the air-particle separation system of FIG. 1, showing its electrical access panel with external controls.

FIG. 6 is a schematic rear view of the air-particle separation system of FIG. 1, with the rear panel and other portions removed to show further internal components.

FIG. 7 is an exploded, schematic rear view of the air-particle separation system of FIG. 1, with some components removed.

FIG. 8 is a schematic left-side view of the air-particle separation system of FIG. 1, showing the latch mechanism of the rear panel.

FIG. 9 is an AC electrical circuit diagram of the air-particle separation system of FIG. 1.

FIG. 10 is a DC electrical circuit diagram of the air-particle separation system of FIG. 1.

FIG. 11 is a hydraulic circuit diagram of the air-particle separation system of FIG. 1.

Similar reference characters denote corresponding features consistently throughout the attached drawings.

### DETAILED DESCRIPTION OF THE PREFERRED EMBODIMENTS

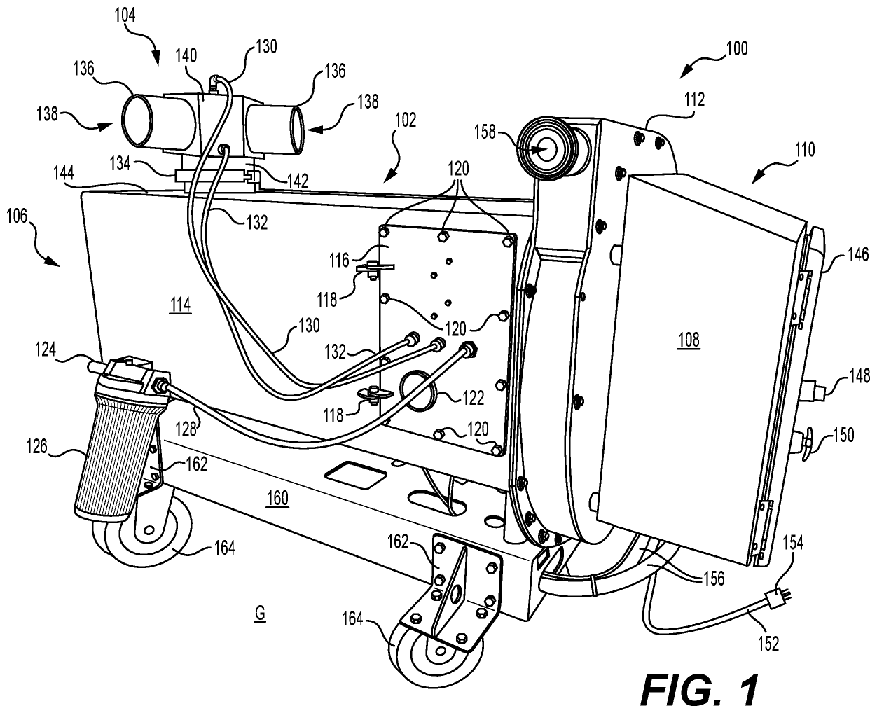

An air-particle separation system 100 is shown in FIGS. 1-2 and 5-8. The air-particle separation system 100 includes a main body 102 with a misting module 104 mounted on the top panel 144 of the main body 102 proximate a left end panel 106 of the main body 102. An electrical control box 108 is mounted to a right end panel 110 of the main body 102. Depending on the air handling requirements, at least one optional high-pressure fan with an outer shroud 112 having an output port 158 may be mounted between the electrical control box 108 and the right end panel 110. More than one high-pressure fan may be necessary to provide increased exhaust, e.g., to operate with an air knife or other equipment requiring a high-pressure air source. The main body 102 includes a front panel 114 with an access panel 116. The access panel 116 is attached to the front panel 114 by two hinges 118 and may be bolted to the front panel 114 with securing bolts 120. The access panel 116 includes a misting water pressure gauge 122, for displaying the misting water pressure, as described below. A water input hose 124 provides water to a cartridge-type water filter 126 mounted on the front panel 114. A filter output tube 128 extends from the water filter 126 to a valve and pressure switch assembly as described below. A misting water tube 130 extends from the valves and pressure switch assembly to the misting module upper chamber body 140. A purging water tube 132 extends from the valves and pressure switch assembly to the misting module lower chamber body 142.

The misting module upper chamber body 140 has a plurality of sides (six shown), with every other side including an air input pipe 136 with an air input port 138 for receiving air with airborne particles from air handling equipment. The air input pipes 136 (three shown) are connected to one or more dust-laden air sources with vacuum hoses, (not shown) while unused pipes 136 may have their input port 138 blocked with a plug, to maintain the required vacuum to the other source(s). The misting module lower chamber body 142 may be formed as a two-piece assembly, as shown. A hose-type clamp 134 detachably holds flanges of the lower and upper portions of the lower chamber body 142 together. While the lower chamber body 142 may be formed as a single piece, the detachable two-piece assembly, as shown, allows the misting module 104 to be removed for cleaning and maintenance.

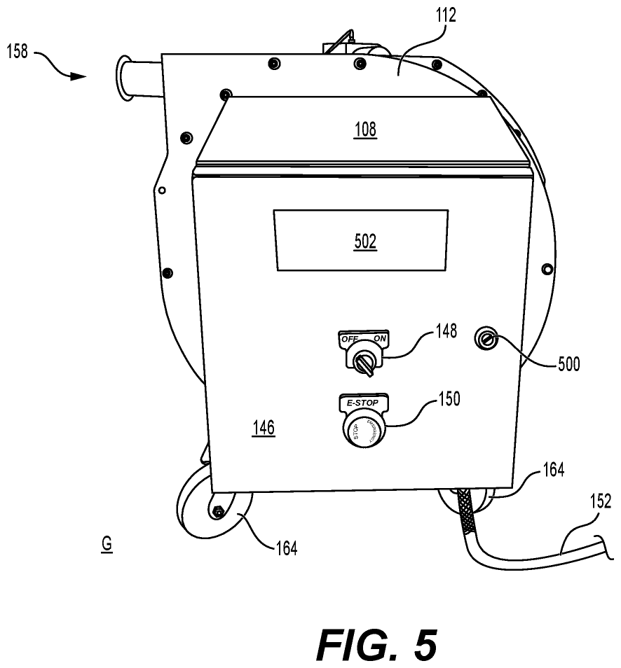

The electrical control box 108 receives electrical power via an electrical input cable 152 with an appropriate electrical input plug 154. A wiring harness 156 connects the electrical components in the electrical control box 108 to electrical components in the main body 102. As best seen in FIG. 5, the electrical control box 108 includes an access door 146 on its outer end. The access door 146 includes a closure fastener 500 which may be a lock to restrict access to the electrical control box 108. The access door 146 also includes an on/off switch 148 and an emergency stop button switch 150 for controlling the air-particle separation system 100, as described in detail below. The access door 146 may also include a touch screen 502 for use in conjunction with an optional programmable logic controller, (PLC) or an optional digital serial interface (DSI) communications module (not shown).

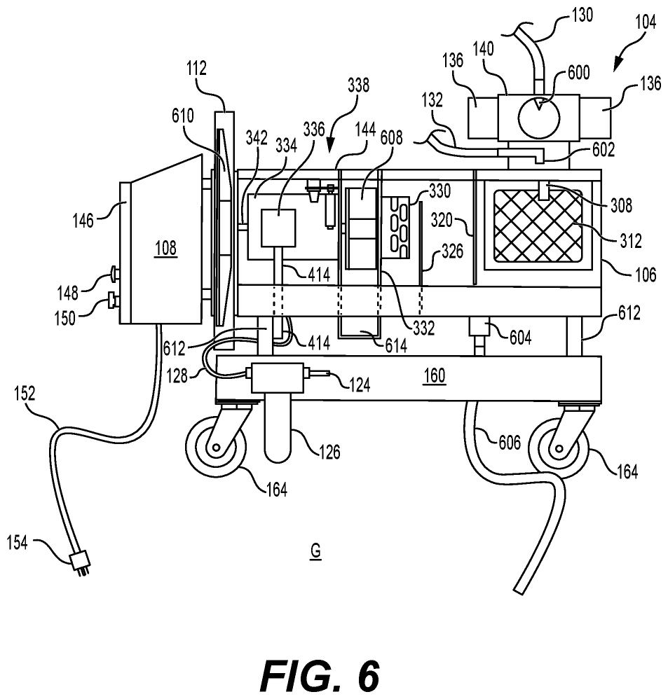

The air-particle separation system 100 may be built into existing equipment or may include a support structure as shown in the figures. As shown in FIG. 6, the support structure includes four support posts 612, that support the main body 102 on a base 160. The base 160 has four base support brackets 162 attached adjacent to its corners. The support brackets 162 may have casters 164, as shown, to allow the system 100 to be rolled into position on the ground G (usually a concrete or other type industrial floor). Alternatively, the casters 164 may be replaced by legs if portability is not required.

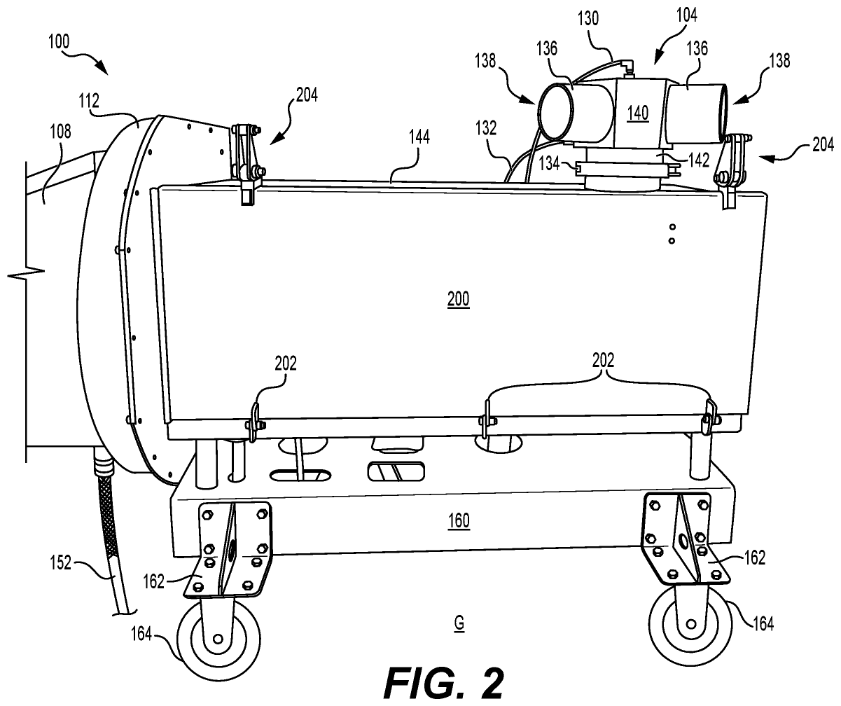

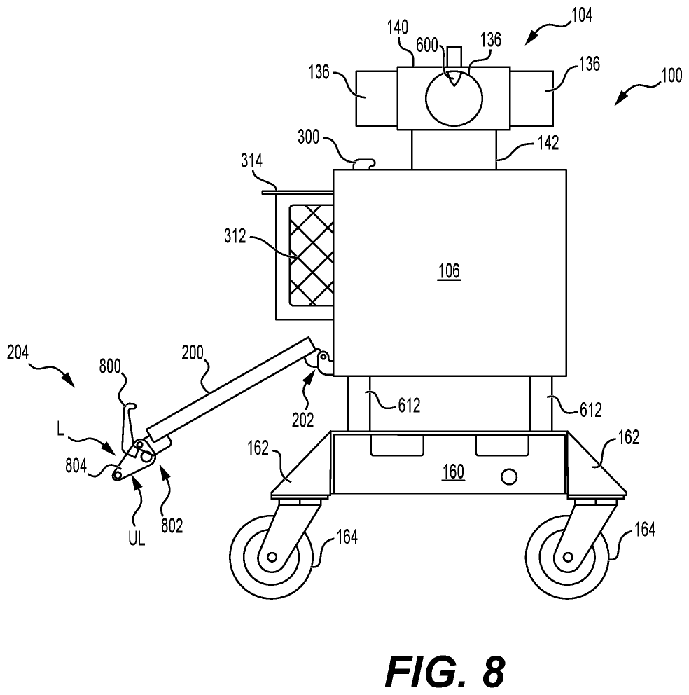

The rear external features of the air-particle separation system 100 are shown in FIGS. 2-3 and 6-8. The rear of the system 100 includes a rear panel 200 that is attached to the main body 102 by hinges 202, such that the panel 200 opens downwardly as shown in FIG. 8 to allow high pressure washdowns (in the food industry), or dry cleaning in other industries. A separator screen 312 (described below) can also be removed through this door for cleaning purposes. The separator screen and the door have safety sensors that will not allow the system to operate if the door is open and/or the separator is not in the proper location.

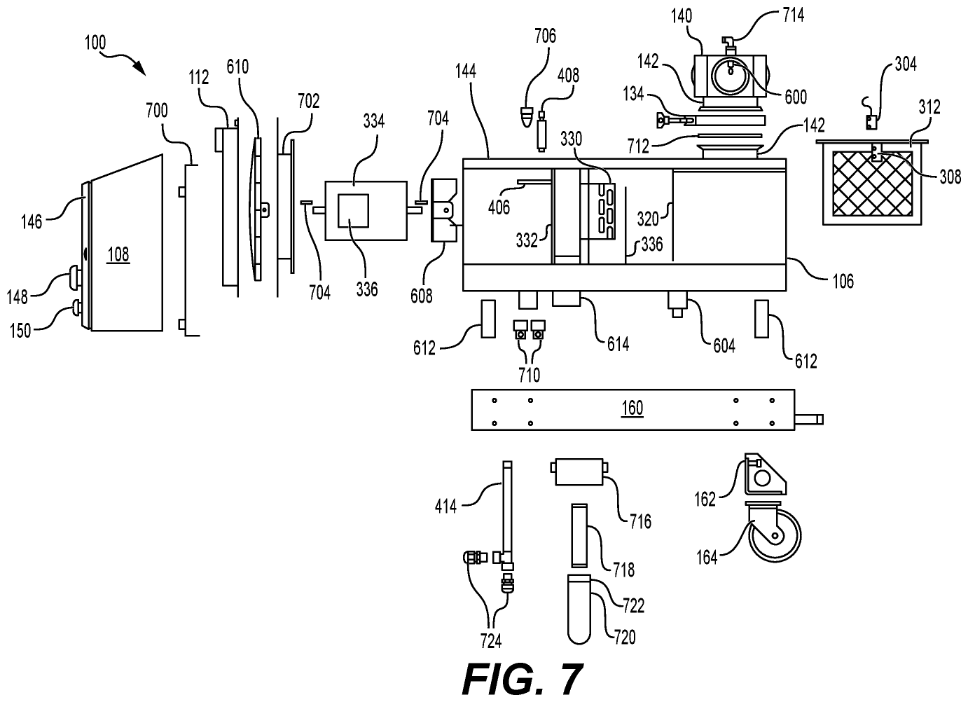

The rear panel 200 includes an end wall 302. The rear panel 200 is held closed by two over-center latches 204. The over-center latches 204 include latch anchors 300 attached to the top panel 144 of the main body 102. Latch hooks 800 are attached to the top edge of the rear panel 200 by over-center latch mechanisms 802 (FIG. 8). The over-center latch mechanisms 802 include latch handles 804. To lock the panel 200 closed, the panel 200 is first rotated to its closed position as shown in FIG. 2 and the latch hooks 800 are placed over the latch anchors 300. The latch handles 804 are then pressed/rotated in the latch direction as indicated by arrow L, until the latches are locked in the over center position as shown in FIG. 2. To unlock the panel, the latch handles 804 are pressed/rotated in the unlatch direction as indicated by arrow UL, until the latch hooks 800 are released from the latch anchors 300 as shown in FIG. 8. As shown in FIG. 7, the water filter 126 can alternatively be disposed in the rear panel of the base 160. As shown in FIG. 6, the water filter 126 includes an upper body 716 with an input port connected to the water input hose 124 and an output port connected to the filter output tube 128. The water filter is in line with the water supply to catch any trash or debris entering into the misting nozzle or nozzles. A filter cartridge 718 is housed in a filter lower body 720 which may be transparent to allow viewing of the filter cartridge 718. External threads 722 on the top of the filter lower body 720 engage internal threads in the upper body 716, to connect the filter lower body 720 to the upper body 716.

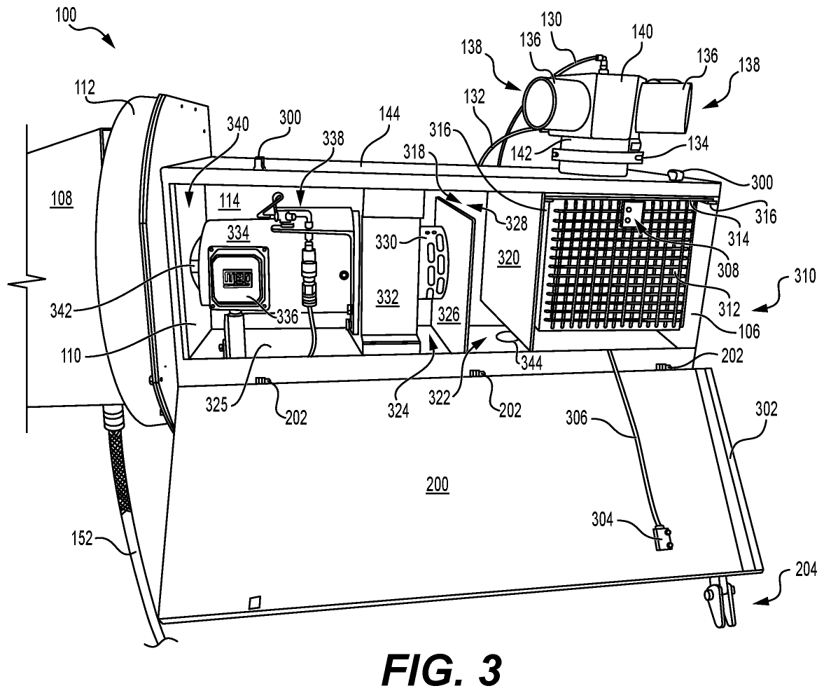

Internal components of the air-particle separation system 100 are shown in FIGS. 3-4 and 6-8. The upper chamber body 140 of the misting module 104 includes a centrally located, downwardly pointing, misting nozzle 600 extending through its top surface. The system 100 has a pressure switch that will not allow the system to run if water is not present.

The misting nozzle 600 is attached to the misting water tube 130 by a swivel elbow 714, to allow movement of the misting water tube 130, to avoid damage to the misting nozzle 600 or the misting water tube 130 (FIG. 7). The screen basket 312 includes an upper frame 314 that is supported on support rails 316 attached to the left end panel 106 and a first chamber wall 320. It should be noted that the porosity (size) of the screen of the screen basket 312 is selected depending on the size of the dust particles. The screen size is selected to be only slightly larger than the average size dust particles. The screen basket 312 can be multi-staged, with different size separator screens, for applications where different sized dust particles are combined together, for example, in sawdust applications.

The screen basket 312 can be removed when the rear panel 200 is open, for cleaning purposes. A basket position and safety interlock sensor 304 mounted on the interior surface of the rear panel 200 includes two contacts that are shorted together by a basket position and safety interlock contact plate 308, when the rear panel 200 is closed and the screen basket 312 is correctly positioned. A sensor wiring harness 306 connects the basket position and safety interlock sensor 304 to the DC electrical circuit of the system 100, as described herein.

In operation, air with particles enters the upper chamber body 140 through the air input ports 138 of the air input pipes 136. As the particles flow in, water from the misting nozzle 600 is sprayed downwardly, soaking the particles within the air stream(s). The water, the water-soaked particles, and the air are directed downwardly into the screen basket 312 that is supported in a first chamber 310 of the main body 102. The screen basket 312 slows the flow of particles to allow sufficient exposure to the water and, thereby, remove them from the air stream. For example, as the dust and water are pulled through the screen, the flow of dust particles slows, allowing the dust particles to become even more saturated.

A centrally located, downwardly pointing screen purging nozzle 602 extends through the sidewall of the lower chamber body 142 of the misting module 104. The screen purging nozzle 602 is periodically supplied with purging water, for removing any particles and other debris stuck to the screen of the screen basket 312. The frequency and purging time can be adjusted depending on the type and amount of particles and debris trapped by the screen. For example, gummy materials require more often and longer purging cycles.

As shown in FIG. 3, the first chamber wall 320 separates the first chamber 310 from the second chamber 318 except for a gap 322 formed between a bottom edge of the first chamber wall 320 and the bottom panel 325. A second chamber wall 326 extends upwardly from the bottom panel 325 and separates the second chamber 318 from a third chamber 324 except for a gap 328 formed between the top edge of the second chamber wall 326 and the top panel 144. The above-described configuration of the chamber walls 320, 326 routes the air stream under the first chamber wall 320 and over the second chamber wall 326 and into the third chamber 324. The velocity of air reduces as it passes through the chambers 310, 318, resulting in the heavy water (saturated with dust particles) falling to the bottom panel 325 within the first chamber 310 and the second chamber 318. A drain or hole 344 in the bottom panel 325 under the first chamber wall 320 leads to a drain tube 604 that can be connected to a drain hose 606, to remove the water, debris and particles from the first chamber 310 and the second chamber 318. The water may then be treated to remove the debris and particles, or simply discarded.

The air stream is drawn into and through the system 100 at least partially by a suction fan. The suction fan includes a cylindrical suction fan input shroud 330, that further restricts any water, debris or particles that are able to enter the third chamber 324 from entering the suction fan. The suction fan further includes centrifugal fan blades 608 that are housed within a suction fan output shroud 332. A fan motor 334 includes a drive shaft 342 that is connected at one end to the suction fan blades 608 and includes a frangible key 704 to protect the fan motor 334 and the suction fan blades 608, in the event of a jammed fan blade or other failure. The bottom of the suction fan output shroud 332 includes a suction fan output port 614 to vent the air from the suction fan out of the system 100. The air may be simply discharged from the port 614 or may be attached to ductwork for routing the pressurized air to further equipment or a remote vent. For example, a separate filter canister system (not shown) can be connected to the port 614 to remove fumes and smells. These types of filter systems remove 99% of any remaining dust and odors. In one example, the suction fan alone is capable of drawing 207 liters per second (440 CFM).

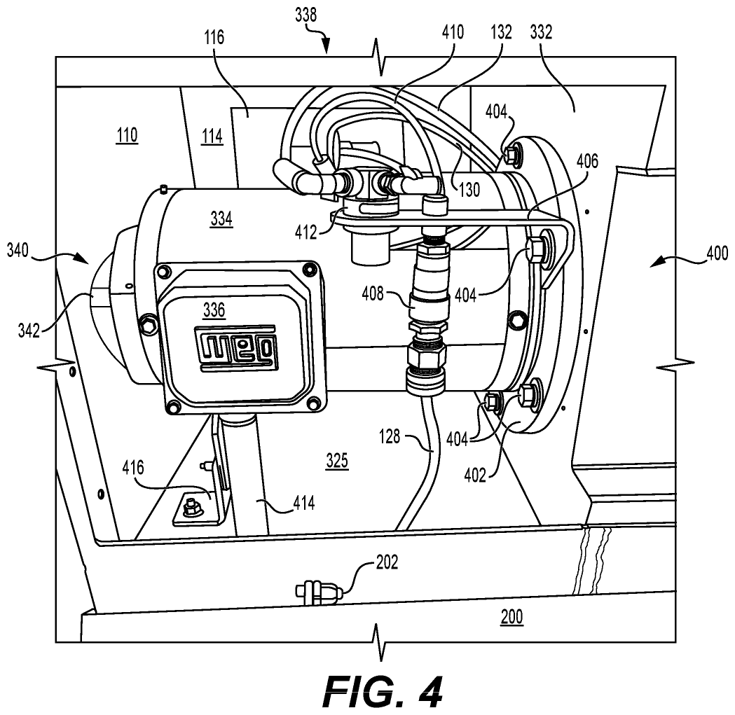

In some applications, a greater air flow rate is required, and/or additional output air pressure and flow may be required. To increase the air flow rate, as previously noted, a high-pressure fan may be mounted between the electrical control box 108 and the right end panel 110 (FIG. 7). The high-pressure fan includes the outer shroud 112 with the output port 158, high pressure fan blades 610 within the outer shroud 112, and a high-pressure fan backplate 702 attached to the outer shroud 112 and to the right end panel 110 of the main body 102. When the high-pressure fan is included, an input port 340 to the high-pressure fan is formed in the right end panel 110, and the second end of the drive shaft 342 of the fan motor 334 extends out of the fan motor body, through the input port 340 and is connected at one end to the high-pressure fan blades 610. In addition, a notch 400 (FIG. 4) is provided in the suction fan output shroud 332 to allow air from the third chamber to go around the suction fan output shroud 332 and enter the input port 340 of the high-pressure fan. As with the suction fan, the connection includes a frangible key 704 to protect the fan motor 334 and the high-pressure fan blades 610, in the event of a jammed fan blade or other failure. The high-pressure fan can provide an additional air flow of 565 liters per second (1200 CFM) or more and can provide clean air for air knife applications or a compressed air source for other applications.

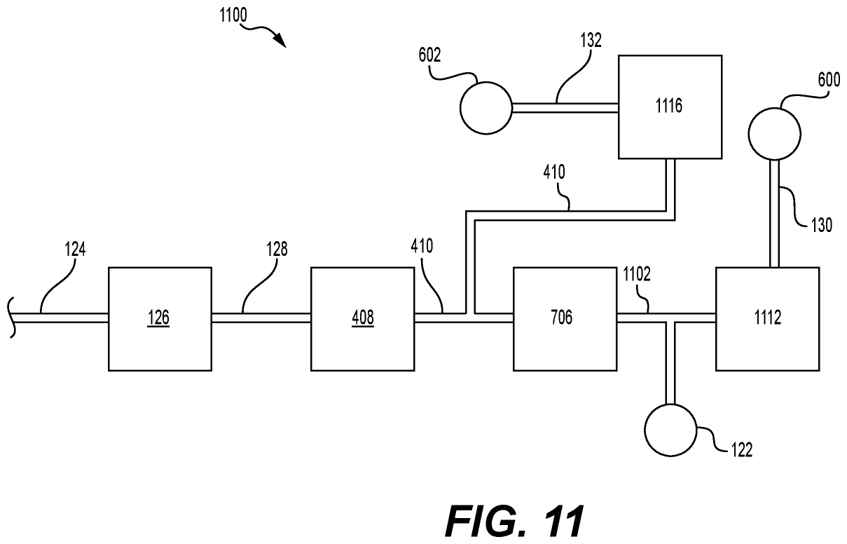

As shown in FIG. 4, the fan motor 334 includes a motor mount flange 402 that is mounted to the suction fan output shroud 332 using a plurality of bolts 404, for supporting the first end of the fan motor 334. Valves and pressure switch assembly 338 may be supported by a valve assembly support bracket 406 that may be secured by one of the bolts 404, as shown. The valves and pressure switch assembly 338 includes a solenoid valve assembly 412 and a water pressure switch 408 that receives water from the filter output tube 128. Unregulated water distribution tubes 410 connect the water pressure switch 408 to the solenoid valve assembly 412 to provide water to the solenoid valve assembly 412 for distribution. The solenoid valve assembly 412 includes water pressure regulator 706, and solenoid valves 710 (water misting solenoid valve 1112 and water purging solenoid valve 1116), the operation of which are described below with respect to FIG. 11. The second end of the fan motor 334 is supported by a fan motor support bracket 416, that may be adjustable to accommodate different diameter motor bodies. A fan motor electrical connection box 336 is attached to the fan motor body to house the electrical connections to the fan motor 334, as is known with electrical motors. The wires from the electrical connection box 336 are routed through a fan motor wiring conduit 414 to the wiring harness, to protect the wires. As shown in FIG. 7, the lower end of the wiring conduit 414 includes two liquid tight connectors 724.

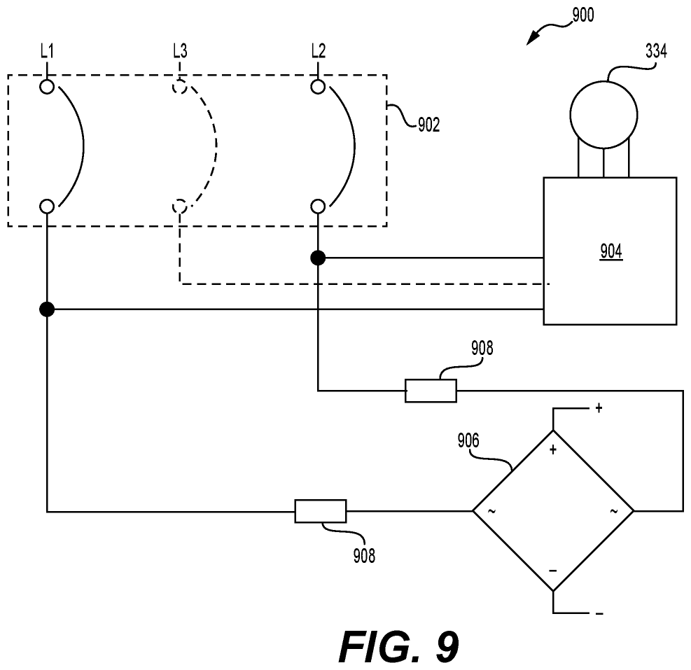

FIG. 9 shows an AC electrical circuit diagram 900 of the air-particle separation system 100. The system 100 can operate over a wide range of AC supply voltages and one, two or three phase systems. In the three phase embodiments, phase A (L1), phase B (L2), and phase C (L3) are all employed. In two phase embodiments, only two of the three phases (for example, L1 and L2) are used, while in single phase embodiments, one of the phases (L1-L3) are used with a neutral, as is known in single phase systems. Input AC voltages may include 120V, 230V, 480V or other standard voltages. A main circuit breaker 902 extends between the input AC power, a variable frequency fan motor drive 904 and a full bridge rectifier 906. Two fuses 908 may also be included to protect rectifier 906. The variable frequency fan motor drive 904 provides a variable frequency AC power to drive the fan motor 334 at different speeds. The motor drive 904 may be a three-phase drive as shown or may be a two-phase or single-phase drive, depending on the type of motor used. The full bridge rectifier 906 provides + and −DC voltages which may be +24 VDC and ground (0 VDC), in one example.

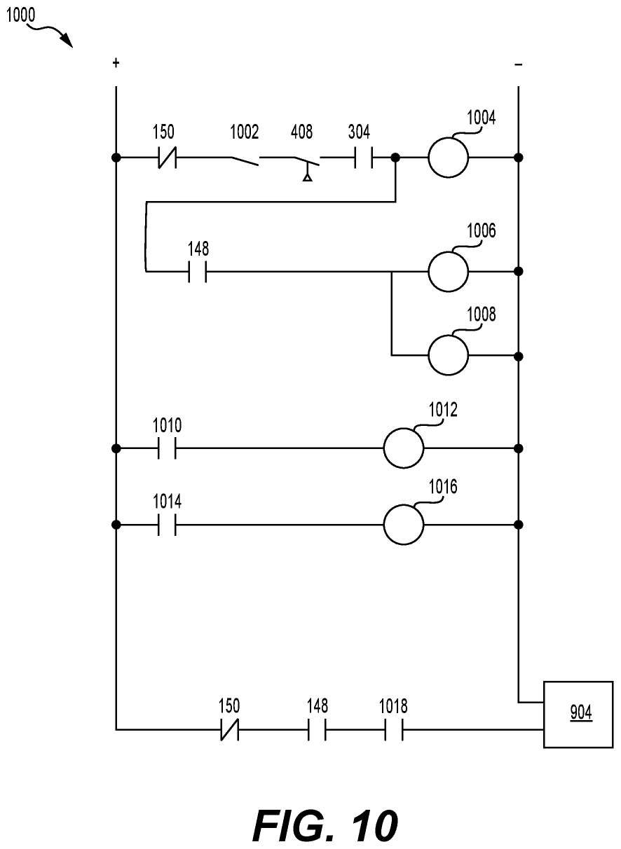

The DC electrical circuit 1000 of the air-particle separation system 100 is shown in FIG. 10, while the hydraulic circuit diagram 1100 of the system 100 is shown in FIG. 11. An emergency stop button switch 150 is closed unless activated. When equipped, the optional DSI communications module provides a go/no go DSI communications switch 1002, that is opened as shown, to prohibit actuation of the system 100 if certain DSI criteria are not met. A water pressure switch 408 is closed if the water pressure sensed is above a predetermined pressure (80 psi is the minimum pressure needed for the purge nozzle). A basket position and safety interlock sensor 304 is closed if the rear panel 200 is closed and the screen basket 312 is appropriately positioned. When the emergency stop button switch 150, the DSI communications switch 1002; the water pressure switch 408 and the basket position and safety interlock sensor 304 are all closed, the +VDC is applied to a system ready indicator light 1004 and to the on/off switch 148.

Once an operator has observed the illuminated system ready indicator light 1004 the on/off switch 148 can be switched to the “on” position, thereby closing the switch 148 and applying the +VDC to a control relay coil 1006 and a time delay purging water relay coil 1008. The control relay includes first control relay contacts 1010 and second control relay contacts 1018, that close when the control relay coil 1006 is energized. When closed, the first control relay contacts 1010 provide +VDC to the solenoid 1012 of the water misting solenoid valve 1112, thereby opening the valve 1112 and providing misting water to the misting nozzle 600 via the misting water tube 130. When closed, the second control relay contacts 1018 provide +VDC (through the closed emergency stop button switch 150 and on/off switch 148) to the variable frequency, inverter-based, fan motor drive 904, thereby activating the fan motor 334. The variable frequency drive 904 allows air flow to be increased or decreased to maximize efficiency.

When the time delay purging water relay coil 1008 is energized, the time delay purging water relay closes its contacts 1014 periodically and for a timed duration. The time delay purging water relay is programmable. For example, the period and times of opening can be programmed based on the system requirements. In some processes, for example, the screen basket 312 may need to be flushed once every hour for 6 seconds. Other processes may need to flush the screen basket 312 more or less frequently, for shorter or longer durations, depending on the amount and type of materials in the air stream. When the contacts 1014 are closed, they provide +VDC to the solenoid 1016 of the water purging solenoid valve 1116, thereby opening the valve 1116 and providing purging water to the screen purging nozzle 602 via the purging water tube 132. Unregulated water is provided to the water purging solenoid valve 1116 and the water pressure regulator 706 from the water pressure switch 408 via unregulated water distribution tubes 410. Pressure regulated water is provided to the water misting solenoid valve 1112 from the water pressure regulator 706 via pressure regulated water distribution tubes 1102 that also provide the pressure regulated water to the misting water pressure gauge 122 on the exterior of the access panel 116. By adjusting the water pressure using the water pressure regulator 706, the misting water flow rate can be adjusted to suit the particular process. For example, a process for collecting dust particles originating from flour may only require a misting nozzle that uses 7.2 liters (1.9 gallons) per hour when provided a 60 psi water pressure supply. For other dust applications, even less misting water may be required, for example 2.4 liters (0.63 gallons) per hour when provided a 20 psi water pressure supply. In addition, different size misting nozzles may be provided depending on the size of the air-particle separation system 100, and the dust handling requirements. Smaller size misting nozzles produce lower flow rates per psi, while larger size misting nozzles produce higher flow rates per psi.

When equipped, the optional programmable logic controller can be controlled by the touch screen 502 and may be used to monitor and control the various system components. If remote sensing and/or control are desired, an optional DSI communications module may also be provided for use in combination with the PLC.

In some embodiments, the air-particle separation system 100 can be made of carbon steel and painted. In other embodiments, for example for use in the food industry, the air-particle separation system 100 can be made of stainless steel, for ease in cleaning and sanitizing.

It is to be understood that the air-particle separation system is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. An air-particle separation system, comprising:
a main body including parallel and opposing front and rear panels and parallel and opposing left and right panels extending between and connecting the front and rear panels;
a first hole extending through the top panel;
a second hole extending through the bottom panel;
a first chamber wall depending from the top panel and extending from the front panel to the rear panel, a bottom edge of the first chamber wall being spaced from the bottom panel, forming a first gap therebetween,
a second chamber wall extending upward from the bottom panel and extending from the front panel to the rear panel, a top edge of the second chamber wall being spaced from the top panel, forming a second gap therebetween;
a first chamber defined within the main body between the left panel and the first chamber wall;
a second chamber defined within the main body between the first chamber wall and the second chamber wall
a third chamber defined within the main body between the second chamber wall and the right panel;
a screen basket with at least one screen, the screen basket being supported in the first chamber below the first hole in the top panel;
a suction fan with an intake port within the third chamber;
a fan motor for driving the suction fan within the third chamber; and
a misting module including a misting nozzle, the misting module configured for receiving air with airborne particles and spraying the airborne particles with water, whereby
the water and water-soaked particles drop to the bottom panel and
the suction fan draws the air under the first chamber wall and over the second chamber wall into the third chamber.

2. The air-particle separation system as recited in claim 1, wherein the suction fan further comprises:
a suction fan output shroud with a bottom having a suction fan output port; and
fan blades housed within the suction fan output shroud, wherein
the fan blades are driven by a fan motor to draw the air through the chambers and out of the suction fan output port.

3. The air-particle separation system as recited in claim 2, wherein the suction fan further comprises a cylindrical suction fan input shroud that restricts water, debris or particles from entering the suction fan intake port.

4. The air-particle separation system as recited in claim 2, further comprising a high-pressure fan, the high-pressure fan including:
an outer shroud with an output port;
high pressure fan blades within the outer shroud; and
a high-pressure fan backplate attached to the outer shroud and to the right end panel.

5. The air-particle separation system as recited in claim 4, further wherein:
an input port of the high-pressure fan is formed in the right end panel; and
the drive shaft of the fan motor includes a second end that extends through the input port of the high-pressure fan and is connected to the high-pressure fan blades.

6. The air-particle separation system as recited in claim 5, wherein a notch is provided in the suction fan output shroud to allow air from the third chamber to go around the suction fan output shroud and enter the input port of the high-pressure fan.

7. The air-particle separation system as recited in claim 1, further comprising:
a centrally located, downwardly pointing screen purging nozzle extending through the misting module; wherein
the screen purging nozzle is periodically supplied with purging water, for removing any particles and other debris stuck to the at least one screen of the screen basket.

8. The air-particle separation system as recited in claim 7, further comprising:
unregulated water distribution tubes connected to a water supply;
a water pressure regulator connected to the unregulated water distribution tubes;
pressure regulated water distribution tubes connected to the water pressure regulator;
a water misting solenoid valve connected to the pressure regulated water distribution tubes and the misting nozzle, for selectively supplying the misting nozzle with pressure regulated water; and
a water purging solenoid valve connected to the unregulated water distribution tubes and the screen purging nozzle, for selectively supplying the misting nozzle with pressure regulated water.

9. The air-particle separation system as recited in claim 8, further comprising:
a rectifier connected to an AC electrical power source for providing a positive and negative DC voltage;
a control relay including a control relay coil, first control relay contacts, and second control relay contacts;
a programmable time delay purging water relay including a time delay purging relay coil, and time delay purging relay contacts;
a motor drive connected to the AC electrical power source and to the fan motor, the motor drive providing electrical power to the fan motor, when activated; and
an on/off switch connected between the positive DC voltage and the control relay coil, the time delay purging relay coil and the motor drive; wherein
the first control relay contacts are connected between the positive DC voltage and the water misting solenoid valve;
the second control relay contacts are connected between the on/off switch and the motor drive;
the time delay purging relay contacts are connected between the positive DC voltage and the water purging solenoid valve; and
when the on/off switch is closed, the control relay coil and the time delay purging relay coil are energized and the motor drive is activated.

10. The air-particle separation system as recited in claim 9, wherein the motor drive is a variable frequency motor drive for driving the fan motor at different speeds.

11. The air-particle separation system as recited in claim 10, further comprising an emergency stop button switch connected in series with the on/off switch between the positive DC voltage and the control relay coil, the time delay purging relay coil and the motor drive.

12. The air-particle separation system as recited in claim 11, further comprising a water pressure switch, wherein the water pressure switch is connected in series with the on/off switch and the emergency stop button switch between the positive DC voltage and the control relay coil.

13. The air-particle separation system as recited in claim 12, further comprising a basket position and safety interlock sensor, the basket position and safety interlock sensor being configured to close when the rear panel is closed and the screen basket is positioned properly.

14. The air-particle separation system as recited in claim 13, further comprising a system ready indicator light connected in series with the on/off switch, the emergency stop button switch, the water pressure switch and the basket position and safety interlock sensor between the positive DC voltage and the negative DC voltage.

15. The air-particle separation system as recited in claim 8, further comprising a misting water pressure gauge connected to the pressure regulated water distribution tubes for displaying the pressure of the water from the water pressure regulator, the water pressure regulator being adjustable to increase or decrease the regulated water pressure.

16. The air-particle separation system as recited in claim 1, wherein the second hole provides a drain leading to a drain tube, to remove water, debris, and particles from the first chamber and the second chamber.

17. The air-particle separation system as recited in claim 4, further comprising an electrical control box mounted to the outer shroud of the high-pressure fan.

18. The air-particle separation system as recited in claim 1, further comprising an electrical control box mounted to the right end panel of the main body.

19. The air-particle separation system as recited in claim 1, wherein the front panel, the rear panel, the left panel, the right panel, the top panel, and the bottom panel of the main body are made of carbon steel.

20. The air-particle separation system as recited in claim 1, wherein the front panel, the rear panel, the left panel, the right panel, the top panel, and the bottom panel of the main body are made of stainless steel.
